(19) United States
(12) Patent Application Publication
(10) Pub. No.: US 2007/0161414 A1
(43) Pub. Date: Jul. 12, 2007

(54) Communication device with flip-cover

(75) Inventors: Shih-Hsuan Wang, Taipei (TW); Po-Yen Chiu, Taipei (TW); Hsiang Chen, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/330,244

(22) Filed: Jan. 12, 2006

(51) Int. Cl. H04M 1/00

(52) U.S. Cl. 455/575.3; 455/550.1

(57) ABSTRACT

The present invention is to provide a communication device comprising a flip-cover including a screen on its inner surface, a phone body including an input unit on its top surface, and a connection member including a first portion pivotably connected to a portion of the flip-cover such that the flip-cover is adapted to pivot about the connection member, and a second portion proximate the first portion pivotably connected to a portion of the phone body such that the phone body is adapted to pivot about the connection member, enabling a pivotal angle of the flip-cover disposing about the phone body to be changed so as to facilitate the operation of text editor and communication functions of the communication device.

### FIELD OF THE INVENTION

The present invention relates to communication devices and more particularly to a mobile communication device having a connection member pivotably connected to a portion of a flip-cover and a second portion pivotably connected to a phone body, enabling a pivotal angle of the flip-cover disposing about the phone body to be changed so as to facilitate the operation of text editor and communication functions of the mobile communication device.

### BACKGROUND OF THE INVENTION

The availability of various new high-technology products (e.g., ones related to computers, mobile communication devices, or the like) is even faster as information technology and electronics industry make progress significantly in recent several decades. The fast development of such new products not only is closely associated with our daily life and work but also shortens time to communicate people located at two different places having a long distance therebetween. Thus, it is impossible of doing without them. In response to many kinds of new communication products (e.g., mobile phones, PDAs (Personal Digital Assistants), portable computers, etc.) being developed by manufacturers and increased popularity among people, market competitiveness is even strong. Moreover, many new communication products available from major communication device manufacturers are featured with compactness, lightweight, and being ease of operation in order to attract more people to buy them. Also, people have an increasing demand to the features and quality of the communication products. Thus, whether communication products to be produced capable of providing more convenient and powerful features will be an indicator to decide whether manufacturing technology related to high-technology products of one country is more advanced than other countries.

A conventional PDA has a keypad having a plurality of keys each representing a numeral or an alphabet in most types of PDA. Typically, PDA is rectangular. In using notepad or scheduler feature of PDA for word processing, a user may create text files. However, the feature of numeral and alphabet represented by a common key as implemented by most PDAs may cause inconvenience in text input by users.

In addition, a camera lens is typically provided at one end of PDA. A user may move PDA and rotate camera lens to take pictures. It is possible that a user cannot see a picture shown on the screen of PDA. Alternatively, it is possible that a person being taken as an object of a picture to be taken cannot see his or her picture on the screen. As a result, picture with poor quality is made. Thus, it is desirable to provide a novel communication device having a flip-cover in order to overcome the inadequacies of the prior art.

### SUMMARY OF THE INVENTION

After considerable research and experimentation, a communication device with a flip-cover according to the present invention has been devised so as to overcome the above drawback of the prior art.

It is an object of the present invention to provide a communication device comprising a flip-cover including a screen on its inner surface, a phone body including an input unit on its top surface, and a connection member including a first portion pivotably connected to a portion of the flip-cover such that the flip-cover is adapted to pivot about the connection member, and a second portion proximate the first portion pivotably connected to a portion of the phone body such that the phone body is adapted to pivot about the connection member. By utilizing the feature of the flip-cover capable of pivoting about the phone body and vice versa, a pivotal angle of the flip-cover disposing about the phone body can be changed so as to facilitate the operation of text editor and communication functions of the communication device.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of communication device having a flip-cover according to the invention where the flip-cover is open;

FIG. 2 is a perspective view of another configuration of the communication device; and

FIG. 3 is an exploded perspective view of the communication device in FIG. 1.

### DETAILED DESCRIPTION OF THE PREFERRED EMBODIMENTS

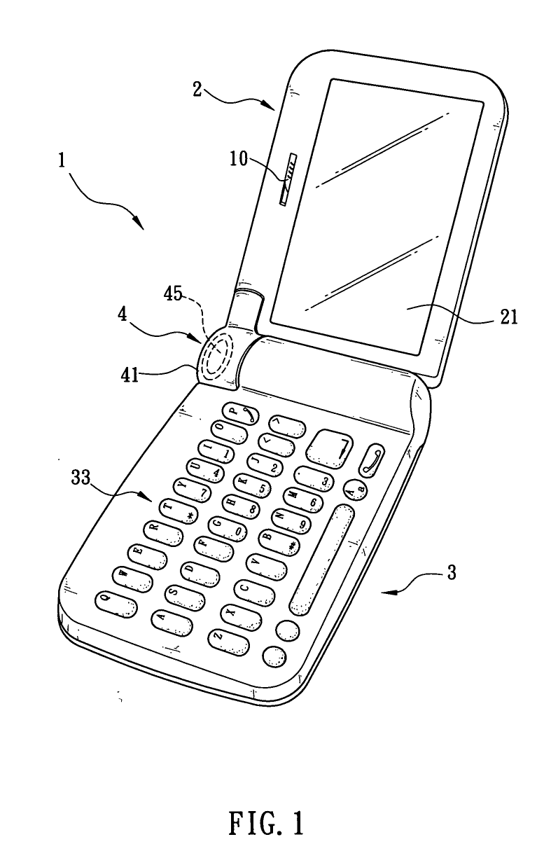

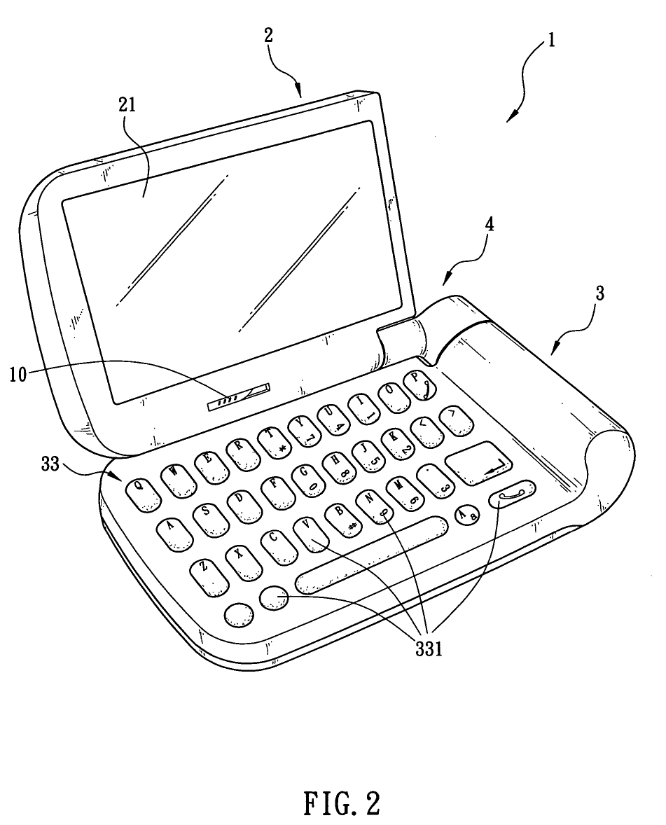

Referring to FIGS. 1 and 2, a communication device (e.g., mobile phone or PDA) 1 in accordance with a preferred embodiment of the invention comprises a flip-cover 2, a phone body 3, and a connection member 4 hingedly interconnecting the flip-cover 2 and the phone body 3. The flip-cover 2 comprises a screen (e.g., touchscreen) 21 on its inner surface. A left corner of a lower end of the flip-cover 2 is pivotably connected to the connection member 4. Thus, the flip-cover 2 is adapted to pivot about the connection member 4. A pivotal joint of the connection member 4 and the flip-cover 2 also serves to pivotably connect to a top left corner of the phone body 3. Thus, the phone body 3 is adapted to pivot about the connection member 4 to engage with the flip-cover 2 (i.e., in a closed position). A top surface of the phone body 3 is formed as an input unit. For a communication device 1 having its flip-cover 2 capable of pivoting at most 360 degrees about the phone body 3 for disposing the flip-cover 2 at a desired angle about the phone body 3, text editor and communication functions of the communication device 1 can be easily operated.

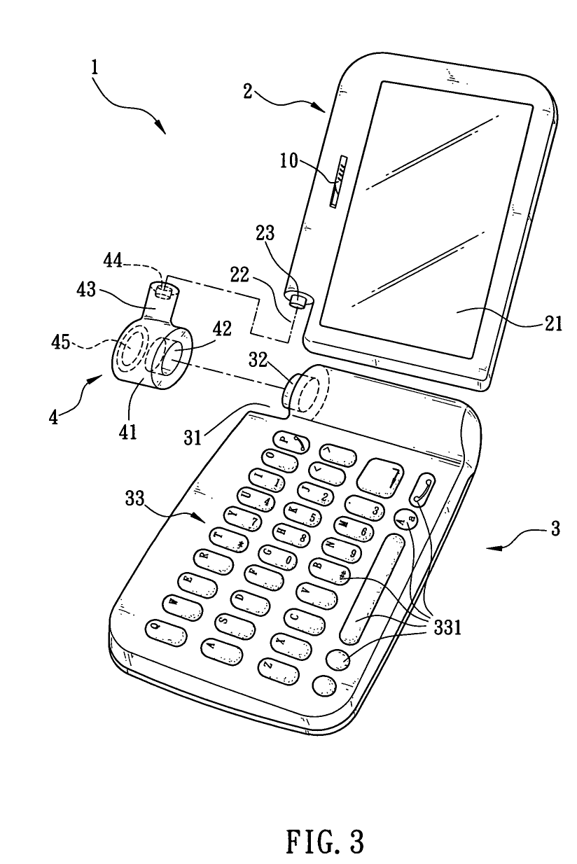

Referring to FIG. 3, in addition the connection member 4 comprises a cylindrical housing 41, a pivot (e.g., cavity as shown or stub shaft) 42 recessed in an inner end of the housing 41, a projection 43 extended from an outer surface of the housing 41, and a pivotal member (e.g., cavity as shown or stub shaft) 44 formed at an open end of the projection 43. The flip-cover 2 comprises a cut portion 22 at its lower left corner, and a first pivot member (e.g., cavity or stub shaft as shown) 23 at the cut portion 22 facing the connection member 4 and being adapted to matingly, pivotably engage with the pivotal member 44. The flip-cover 2 is thus able to rotate relative to the connection member 4 about the first pivot member 23 with the projection 43 disposed in the cut portion 22. Similarly, the phone body 3 comprises a cut portion 31 at its top left corner, and a second pivot member (e.g., cavity or stub shaft as shown) 32 at the cut portion 31 facing the connection member 4 and being adapted to matingly, pivotably engage with the pivot 42. The second pivot member 32 is adapted to pivotably connect to the pivot 42. Thus, a pivotal rotation of the projection 43 in one direction may close the flip-cover 2 onto the phone body 3 with the housing 41 disposed in the cut portion 31.

Referring to FIG. 3 again, in the embodiment the phone body 3 further comprises a keypad 33 formed on its top surface facing the flip-cover 2. The keypad 33 comprises a plurality of keys 331 each printed with an icon, a numeral and an alphabet, a numeral and a character, a numeral, or alphabet(s). The numeral is disposed perpendicularly to the adjacent alphabet on the same key. A user may pivot the flip-cover 2 in an opposite direction relative to the phone body 3 about the second pivot member 32 for opening the communication device 1 (i.e., exposing the keypad 33). Thus, the user may press the keys (i.e., numerals of the keys) of the keypad 331 in a dialing operation of the communication device 1. This is the same operation as a typical communication device. That is, it operates in a manner the same as making a call on a typical telephone. Alternatively, the user may pivot the flip-cover 2 in a direction relative to the phone body 3 about the first pivot member 23 for also opening the communication device 1 (i.e., exposing the keypad 33). Thus, the user may press the keys (i.e., alphabets of the keys) of the keypad 331 in a text input operation of the communication device 1. This is the same operation as a text editor of a typical word processing device. That is, it operates in a manner the same as a typical data input. In brief, changing a direction of the flip-cover 2 relative to the phone body 3 will change a text editor function of the communication device to a communication function thereof or vice versa. Further, a camera lens 45 is provided on an outer end of the connection member 4 opposite the pivot 42. Thus, pivoting the flip-cover 2 about the second pivot member 32 will dispose the screen 21 of the flip-cover 2 in an angle appropriate for viewing.

Referring to FIGS. 1 and 3 again, in the embodiment the connection member 4 further comprises an image conversion switch 10. A user may decide an image shown on the screen 21 based on an angle of the flip-cover 2 relative to the phone body 3. For example, the user may open the image conversion switch 10 when the flip-cover 2 is increasing its angle relative to the phone body 3 by pivoting about the second pivot member 32 (i.e., in an open position of the communication device 1). The image conversion switch 10 thus activates an image conversion device (not shown) of the communication device 1. As a result, an angle of image shown on the screen 21 is changed about 180 degrees. This is an angle suitable for viewing image when a communication function of the communication device 1 is activated. Alternatively, the user may close the image conversion switch 10 when the flip-cover 2 is increasing its angle relative to the phone body 3 by pivoting about the first pivot member 23 (i.e., in an open position of the communication device 1). As a result, an angle of image shown on the screen 21 returns to its original angle. This is an angle suitable for viewing image when a text editor function of the communication device 1 is activated.

While the invention herein disclosed has been described by means of specific embodiments, numerous modifications and variations could be made thereto by those skilled in the art without departing from the scope and spirit of the invention set forth in the claims.

What is claimed is:

1. A communication device comprising:
a flip-cover including a screen on its inner surface;
a phone body including an input unit on its top surface; and
a connection member including a first portion pivotably connected to a portion of the flip-cover such that the flip-cover is adapted to pivot about the connection member, and a second portion proximate the first portion pivotably connected to a portion of the phone body such that the phone body is adapted to pivot about the connection member.

2. The communication device of claim 1, wherein the connection member comprises a cylindrical housing, a pivot formed in an inner end of the housing, a projection extended from an outer surface of the housing, and a pivotal member formed in an open end of the projection, the pivotal member being pivotably connected to the portion of the flip-cover.

3. The communication device of claim 2, wherein the flip-cover further comprises a cut at one corner of its lower end, and a first pivot member at the cut facing the connection member and being adapted to matingly, pivotably engage with the pivotal member such that the flip-cover is adapted to rotate relative to the connection member about the first pivot member with the projection being disposed in the cut.

4. The communication device of claim 3, wherein the phone body further comprises a cut portion at one corner of its top end, and a second pivot member at the cut thereof facing the connection member and being adapted to matingly, pivotably engage with the pivot such that a pivotal rotation of the projection is adapted to close the flip-cover onto the phone body with the housing being disposed in the cut of the phone body.

5. The communication device of claim 3, wherein the phone body further comprises a keypad formed on its top surface facing the flip-cover, the keypad including a plurality of keys each printed with a numeral and an alphabet disposed perpendicularly to the adjacent numeral on the same key.

6. The communication device of claim 4, wherein the phone body further comprises a keypad formed on its top surface facing the flip-cover, the keypad including a plurality of keys each printed with a numeral and an alphabet disposed perpendicularly to the adjacent numeral on the same key.

7. The communication device of claim 5, further comprising a camera lens provided on an outer end of the connection member opposite the pivot.

8. The communication device of claim 6, further comprising a camera lens provided on an outer end of the connection member opposite the pivot.

9. The communication device of claim 5, wherein the connection member further comprises an image conversion switch for determining an image shown on the screen.

10. The communication device of claim 6, wherein the connection member further comprises an image conversion switch for determining an image shown on the screen.

11. The communication device of claim 5, wherein the communication device is a mobile phone.

12. The communication device of claim 6, wherein the communication device is a mobile phone.

13. The communication device of claim 5, wherein the communication device is a PDA.

14. The communication device of claim 6, wherein the communication device is a PDA.

15. The communication device of claim 5, wherein the screen is a touchscreen.

16. The communication device of claim 6, wherein the screen is a touchscreen.
